(19) United States
(12) Patent Application Publication
(10) Pub. No.: US 2014/0145936 A1
(43) Pub. Date: May 29, 2014

(54) METHOD AND SYSTEM FOR 3D GESTURE BEHAVIOR RECOGNITION

(71) Applicant: KONICA MINOLTA LABORATORY U.S.A., INC., SAN MATEO, CA (US)

(72) Inventors: Haisong GU, Cupertino, CA (US); Yongmian ZHANG, Union City, CA (US)

(73) Assignee: KONICA MINOLTA LABORATORY U.S.A., INC., SAN MATEO, CA (US)

(21) Appl. No.: 14/090,207

(22) Filed: Nov. 26, 2013

Related U.S. Application Data
(60) Provisional application No. 61/731,180, filed on Nov. 29, 2012.

(51) Int. Cl. G06F 3/01

(52) U.S. Cl. CPC G06F 3/017
USPC 345/156

(57) ABSTRACT

A method for 3D gesture behavior recognition is disclosed, which includes detecting a behavior change of one or more attendees at a meeting and/or conference; classifying the behavior change; and performing an action based on the behavior change of the one or more attendees. Another method, system and computer readable medium for 3D gesture behavior recognition as disclosed, includes obtaining temporal segmentation of human motion sequences for one or more attendees; determining a probability density function of the temporal segmentations of the human motion sequences using a Parzen window density estimation model; computing a bandwidth for determination of a median absolute deviation; updating the Parzen window to adapt for changes in the motion sequences for the one or more attendees; and detecting actions based.

### CROSS REFERENCE TO RELATED APPLICATION(S)

This application claims priority under 35 U.S.C. §119(e) to U.S. provisional application No. 61/731,180, filed on Nov. 29, 2012, the entire contents of which is incorporated herein by reference in its entirety.

### FIELD

This disclosure relates to a method and system for gesture behavior recognition.

### BACKGROUND

Current conference (local and/or remote) systems can present one or more issues for both remote and local meeting room attendees. For example, for remote attendees, the difficulties or limitations can include an inability to conduct side conversations, in-room attendees forget or lose consciousness about remote attendees, and it can be challenging for remote attendees to break into lively conversation. In addition, it can also be difficult for remote attendees to detect in-room speaker changes, to identify other attendees or individuals within the meeting room, identify the current speaker, and/or participate in brain-storming sessions. Moreover, often remote attendees cannot see in-room demonstrations or artifacts.

Alternatively, for a local meeting room, the limitations can include local people are more emotionally salient than remote participants, it can be easy to forget about remote participants, and the speaker may not pay attention to the subtle and meaningful behavior changes of local attendees. In addition, current systems lack any type of content delivery system for late arriving (or jump-in) attendees to catch up with the current meeting by being providing the content or information that was presented before the late attendee arrived and/or began participating at the conference and/or meeting.

In addition, visualization (visual channel) is important when people discuss objects and/or documents. For example, it is often helpful to identify who is speaking and to focus the camera or signal on the speaker, which can help understand verbal referring expressions.

U.S. Patent Publication No. 2007/0124682 A1, entitled “Conference support system, conference support method and program product for managing progress of conference”, aims at managing progress of a conference for a plurality of conference subjects.

U.S. Pat. No. 7,262,788 entitled “Conference support system, information displaying apparatus, machine readable medium storing thereon a plurality of machine readable instructions, and control method”, supports the progress of the proceedings by making the contents of the conference understand easily to the attendant of the conference, based on the method of speaker's gaze direction detection.

U.S. Patent Publication No. 2010/0303303A1 entitled “Method for Recognizing Pose and Action of Articulated Objects with Collection of Planes in Motion”, describes a method for obtaining the body pose through a triplet of articulated objects with collection of planes in motion over frames, while the motion of a set of points moving freely in space or moving as part of an articulated body can be decomposed into a collection of rigid motions of planes defined by every triplet of points and by assuming camera focal length. The action recognition is performed to identify the sequence from the reference sequences such that the subject in performs the closest action to that observed by matching the pose transitions with a template of body pose of known actions in a database.

The paper by Dian Gong, Gerard Medioni, Sikai Zhu, and Xuemei Zhao, entitled “Kernelized Temporal Cut for Online Temporal Segmentation and Recognition”, In Proceeding of ECCV, 2012, addresses the problem of unsupervised online segmenting human motion sequences into different actions. Kernelized temporal cut is proposed to sequentially cut the structured sequential data into different regimes. This method extends the existing method of online change-point detection by incorporating Hilbert space embedding of distributions to handle the nonparametric and high dimensionality issues. The proposed approach is able to detect both action transitions and cyclic motions at the same time.

### SUMMARY

In consideration of the above issues, it would be desirable to have a method and system for 3D behavior recognition, which can be used for local and remote meetings and/or conferences, sporting events, office environments, and studio or broadcasting of live television and television events.

In accordance with an exemplary embodiment, a method for 3D gesture behavior recognition is disclosed, the method comprising: detecting a behavior change of one or more attendees at a meeting and/or conference; classifying the behavior change; and performing an action based on the behavior change of the one or more attendees.

In accordance with another exemplary embodiment, a method for 3D gesture behavior recognition is disclosed, comprising: obtaining temporal segmentation of human motion sequences for one or more attendees; determining a probability density function of the temporal segmentations of the human motion sequences using a Parzen window density estimation model; computing a bandwidth for determination of a median absolute deviation; updating the Parzen window to adapt for changes in the motion sequences for the one or more attendees; and detecting periodic or non-periodic actions based.

In accordance with a further exemplary embodiment, a system for 3D gesture behavior recognition is disclosed, the system comprising: a monitoring module having executable instructions for: obtaining temporal segmentation of human motion sequences for one or more attendees; determining a probability density function of the temporal segmentations of the human motion sequences using a Parzen window density estimation model; computing a bandwidth for determination of a median absolute deviation; updating the Parzen window to adapt for changes in the motion sequences for the one or more attendees; and detecting periodic and non-periodic actions; a control module for: changing a focus of a video camera and/or audio channel; giving advice or support to a current speaker; and/or providing information to a new attendee; and a content management module for: registering a profile and/or profile information for each individual or attendee at a conference and/or meeting; and/or summarizing contents of a current conversation and/or meeting for real-time attending assistance and future content browsing.

In accordance with another exemplary embodiment, a non-transitory computer readable medium containing a computer program having computer readable code embodied therein for 3D gesture behavior recognition is disclosed, comprising: obtaining temporal segmentation of human motion sequences for one or more attendees; determining a probability density function of the temporal segmentations of the human motion sequences using a Parzen window density estimation model; computing a bandwidth for determination of a median absolute deviation; updating the Parzen window to adapt for changes in the motion sequences for the one or more attendees; and detecting periodic and non-periodic actions based.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is an illustration of a system for 3D gesture behavior recognition in accordance with an exemplary embodiment;

FIG. 2 is an illustration of a system for online segmentation and recognition in accordance with an exemplary embodiment;

FIG. 3 is an illustration of a method for 3D behavior recognition in accordance with an exemplary embodiment;

FIG. 4 is an illustration of a human skeleton system showing (a) moving body joints, and (b) a joint in the spherical coordinate in accordance with an exemplary embodiment;

FIG. 5 is an illustration a Parzen window update in accordance with an exemplary embodiment;

FIG. 6 is an illustration of a minimal length of an action in accordance with another exemplary embodiment;

FIG. 7 shows a user performing a single action (twist upper body) in one video sequence, wherein at the top of the figure shows body skeleton and the bottom of the figure is the probability distribution of no action (line 1) modeled by an exemplary embodiment as disclosed herein and the detected action periods (line 2);

FIG. 8 shows a user performing two different actions (raise the hand and put down the hand) in one video sequence, wherein the top figure shows body skeleton, and the bottom figure is the probability distribution of no action (line 1) modeled by an exemplary embodiment as disclosed herein and the detected action periods (line 2); and

FIG. 9 shows a user performing three different actions in one video sequence, wherein the top figure shows body skeleton and the bottom figure is the probability distribution of no action (line 1) computed by an exemplary embodiment as disclosed herein and the detected action periods (line 2).

### DETAILED DESCRIPTION

Reference will now be made in detail to the embodiments of the disclosure, examples of which are illustrated in the accompanying drawings. Wherever possible, the same reference numbers are used in the drawings and the description to refer to the same or like parts.

In accordance with an exemplary embodiment, the present disclosure utilizes 15 skeleton joints to represent human articulated parts. In accordance with an exemplary embodiment, the present disclosures (1) uses motion capture data and/or a depth map to generate the position of the 15 skeleton joints of articulated body parts in 3D space; (2) the action transition is detected through a Parzen-window probability estimation; and (3) the action recognition is performed by fusing the results from action classifiers trained by using a multiple instance Adaboost algorithm and from action sequence matching using dynamic time warping.

In accordance with an exemplary embodiment, the present disclosure derives the probability model by using the theory of Parzen-Window estimation. In accordance with an exemplary embodiment, the method and system models the probability density of 11 human articulated parts in a 3D spherical coordinate system. In accordance with an exemplary embodiment, one of the benefits of the disclosed probability model is that the method and system takes account for the dependence of the movement of human articulated parts, which describes more naturally the movement of human articulated parts, for example, the movement of the left upper arms, which affects the movement of the left lower arm.

In accordance with another exemplary embodiment, the method and system can use 2D (two-dimensional) information of articulated parts to constrain the joint movement of skeleton system so that the method and system can achieve more accurate in 3D position of all joints.

In accordance with a further exemplary embodiment, the method and system's probability model is configured to model 11 individual moving parts so that the method and system knows which group of parts is acting within an action boundary. For example, as a result, actions that are not related to a group of parts can be eliminated before the action recognition stage.

In accordance with another exemplary embodiment, the method and system can use the Bayesian fusion of multiple action classifiers to increase the recognition robustness.

In accordance with an exemplary embodiment, a 3D gesture behavior recognition system and method is disclosed, which includes online action segmentation and action transition detection by exploring non-parametric kernel based probability modeling with motion capture and depth sensor data. In accordance with an exemplary embodiment, first, the body moving components such as head, shoulders and limbs are represented by a line segment based model. Each line segment has two joints associated with its two ends so that the position of a line segment in the 3D space can be determined by the skeleton joints. Second, the movement of a line segment (e.g., a moving body component) can be modeled by a non-parametric kernel based probability density function in an adaptive window. Third, the accuracy of the line segment in the 3D space can be improved by eliminating the outlier of joint movement by using foreground motion segmentation and depth map. Fourth, the boundaries of action segmentation can be detected by the union of total line segment probability estimators. Finally, actions can be recognized by fusing the template matching result and the classification result from dynamic time warping and a trained action classifier, respectively.

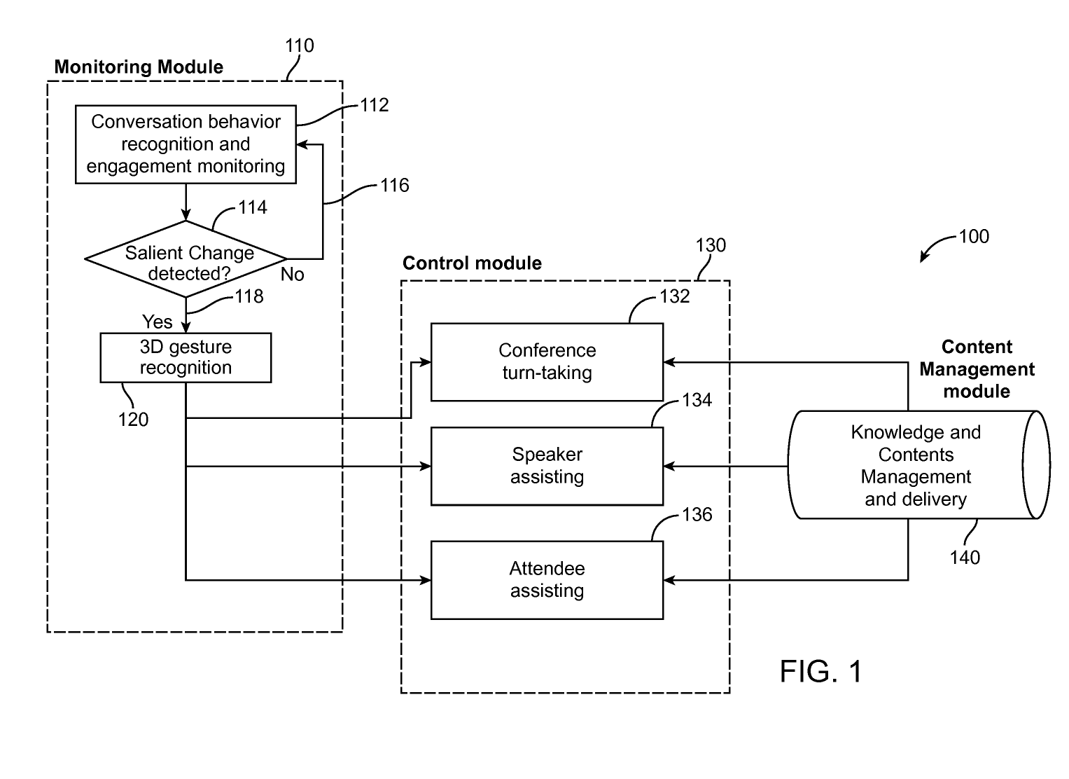

In accordance with an exemplary embodiment as shown in FIG. 1, the system for 3D gesture behavior recognition 100 can include a visual channel based real-time monitoring module 110 having a 3D gesture recognition detection module or system 120, a controlling module 130, and a content management delivery module 140. Based on the results of conversation behavior recognition and engagement analysis from the monitoring module 110, the system 100 detects meaningful behavior changes of individuals and/or groups (for example, attendees at a conference and/or meeting), via motion detection or other visual detection methods. As shown in FIG. 1, the monitoring module 110 can monitor conversation behavior via a conversation behavior recognition and engagement monitoring module 112. If a salient change (e.g., a prominent change in the actions of the speaker and/or attendees) 114 is not detected 116, the conversation behavior recognition and engagement monitoring module 112 continues to monitor the attendees. However, once a salient change is detected 118, a 3D gesture recognition detection unit 120 can be used to analyze the intention and emotion of the individual(s) or attendee(s) obtained from the monitoring module 110. The actions and/or results of the detected salient changes are forwarded to the control module 130. In accordance with an exemplary embodiment, based on the behavior recognition results as determined by the monitoring module 110, the in controlling module 130 can (1) change the view focus of camera and audio channel(s) to a new attendee if it identifies that a new center of the conversation has transpired turn-taking) 132, and/or (2) give advice or support to the current speaker if the module recognizes that another attendee has a special request (e.g., speaker assisting) 134, and/or (3) provide the necessary information to the new attendee if finding a new attendee jump-in the conference (e.g., attending assisting) 136.

In accordance with an exemplary embodiment, the knowledge and contents management and delivery module (or content delivery module) 140 can be configured to register a profile and/or profile information for each individual or attendee at a conference and/or meeting. In addition, the content delivery module 140 can be configured to summarize the contents of a current conversation and/or meeting for real-time attending assistance and future content browsing.

Each of the real-time monitoring module 110, the 3D gesture recognition detection module or system 120, the controlling module 130, and the content management delivery module 140 can include one or more computer or processing devices having a memory, a processor, an operating system and/or software and/or an optional graphical user interface and/or display.

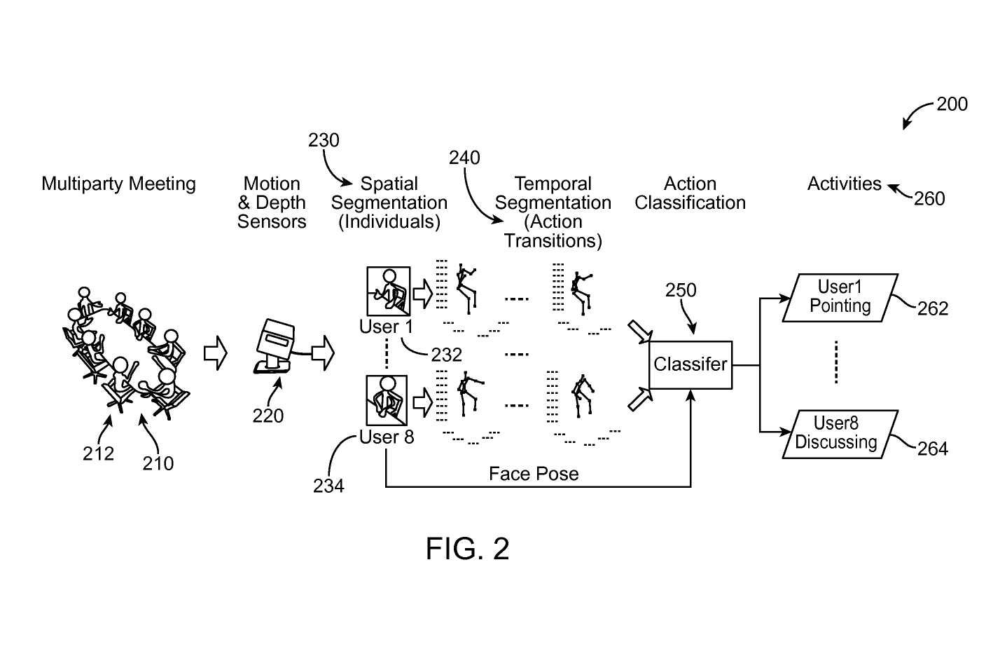

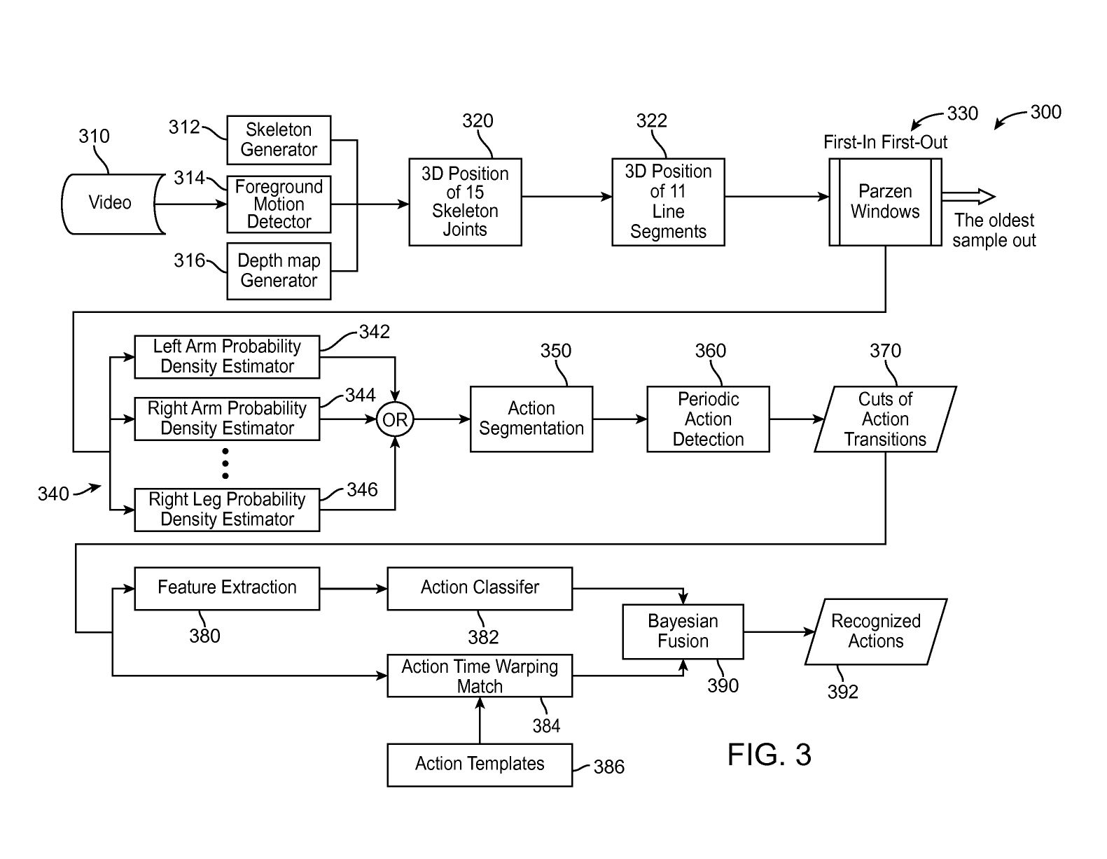

In accordance with an exemplary embodiment, for 3D gesture behavior recognition, the method and system can use a real-time action segmentation and action transition detection method, which explores non-parametric kernel based probability modeling with motion capture and depth sensor data. An overview of this subsystem 200 can be seen in FIG. 2, while FIG. 3 shows a functional view of the method.

As shown in FIG. 2, the subsystem 200 comprises a multiparty meeting 210 having one or more motion and/or depth sensors 220, spatial segmentation 230 for one or more individuals or users 232, 234, temporal segmentation 240 of the one or more individuals or users, an action classifier 250, and activities 260 of the one or more users 262, 264. For example, the multiparty meeting 210 can include a plurality of individuals and/or users 212, which can be in one or more locations, which can include both remote users and/or local users. The motion and depth sensors 220 can includes video cameras and/or other known motion and depth sensors and/or devices. For example, the video cameras can include 2D (two-dimensional) and/or 3D (three-dimensional) video camera technology.

In accordance with an exemplary embodiment, the spatial segmentation 230 of the individuals or users 232, 234 is performed using the motion and depth sensor 220 and/or can be retrieved from a database stored on a memory device. The temporal segmentation 240 of the one or more users 212 is delivered to an action classifier 250, which outputs activities 260, which can include pointing (e.g., user 1) 262 and discussing (e.g., user 8) 264. Additional output activities 260 can include raising one or both hands, nodding of the head, head shaking, waving, and other hand, arm, and head gestures.

Previous work on temporal segmentation can be mainly divided into two categories: statistic approach and clustering approach. The statistic approaches are often restricted to univariate series (one-dimension or 1D). Though temporal clustering approaches can handle multivariate data, they are usually performed offline. Accordingly, in accordance with an exemplary embodiment, the real-time temporal segmentation 240 of action transitions from a video sequence of video sequencing can be a crucial step in action recognition as disclosed herein.

FIG. 3 shows an overview of a method for online action segmentation and recognition 300. As shown in FIG. 3, the method 300 can include one or more video cameras 310 (or motion or depth sensors), which can process the images from the one or more video cameras 310 to include a skeleton generator 312, a foreground motion detector 314, and a depth map generator 316. In accordance with an exemplary embodiment, the skeleton generator 312, the foreground motion detector 314, and the depth map generator 316 can be used to determine a 3D position of the 15 skeleton joints 320 of an attendee and/or user. The 15 skeleton joints 320 can then be used to generate 3D positions of the 11 line segments (or indices) 322. The 11 line segments are further described in Table 1. In accordance with an exemplary embodiment, the 3D position of the 11 line segments 322 can then be fed into a non-parametric kernel based probability modeling system or a Parzen Window 330 on a first-in first-out basis. The modeling system or Parzen Window 330 can then be used to determine a plurality of density estimators 440 in connection with the 11 line segments. For example, the plurality of density estimators 440 can include one or more of the 11 line segments as shown in Table 1 or a combination of one or more line segments. For example, the plurality of density estimators can include a left arm probability density estimator 342, a right arm probability density estimator 344, a left leg probability density estimator (not shown), and right leg probability density estimator 346.

In accordance with alternative exemplary embodiment, the method can include in step 350, action segmentation, in step 360, periodic and non-periodic action detection, and in step 370, boundaries of action transitions. In step 380, feature extraction is performed by a computer or computer process, which can in step 382 perform an action classification, in step 384, action time warping match, and in step 386, action templates. In step 390, the results are fed into Bayesian Fusion algorithm, which produce in step 392, a recognized action.

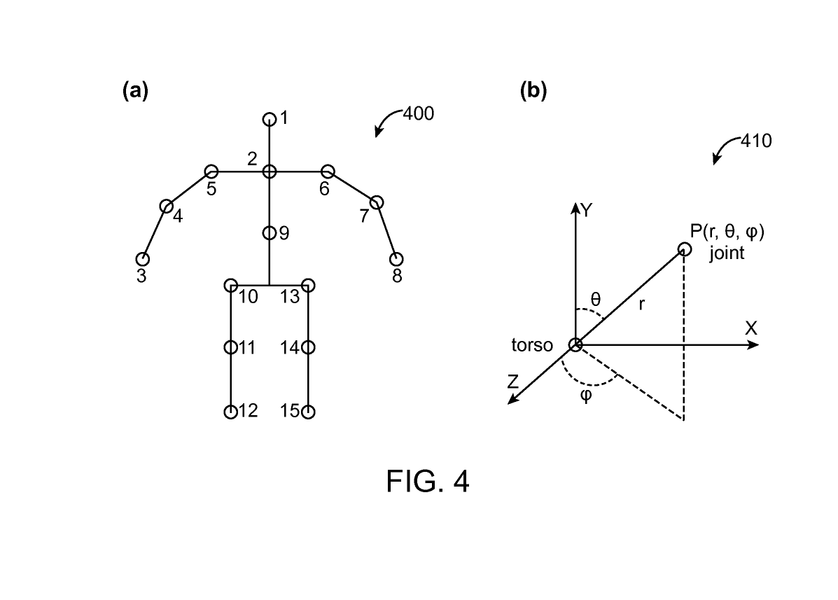

In accordance with an exemplary embodiment, first, the body moving components such as head, shoulders and limbs can be represented by 15 skeleton joints, which can generate the corresponding 11 line segments. Each line segment can have two joints (of the 15 skeleton joints as shown in FIG. 4(a)) associated with the two ends of the joints so that the position of a line segment in the 3D space can be determined by the skeleton joints. In accordance with an exemplary embodiment, the line segments can be mutually connected by an overlapped joint to take account of the spatial dependency in the probability modeling. Second, the movement of a line segment (a moving body component) can be modeled by a non-parametric kernel based probability density function in a Parzen window. In accordance with an exemplary embodiment, the Parzen window update can be performed in a first-in first-out manner, which allows the method and process to estimate the density function more accurately and depending only on recent information from the sequence. Third, the accuracy of the line segment in the 3D space can be achieved by eliminating the outlier of joint movement by using foreground motion segmentation and depth map. Fourth, the boundaries of action segmentation can be detected by the union of 11 line segment probability estimators. The detected action segmentation can be composed of several periodic and non-periodic actions (cyclic motion). In accordance with an exemplary embodiment, the method and system can use a sliding-window strategy with dynamic time warping to test whether the action segmentation composes of periodic and non-periodic actions and to find the transition between periodic and non-periodic actions. Fifth, actions can be recognized by using the template matching result and the classification result from dynamic time warping and a trained action classifier, respectively.

Body Skeleton System

In accordance with an exemplary embodiment, a temporal segmentation of human motion sequences is a crucial step for human action recognition and activity analysis. For example, an action can be described as the movement of a person's head, shoulders and other limbs of body. In accordance with an exemplary embodiment, the movement can be described by the skeletal structure of the human body. FIG. 4(a) illustrates skeleton representation 400 for an exemplar user facing the visual sensor where the skeleton consists of 15 joints and 11 line segments representing head, shoulders and limbs of human body. As shown in FIG. 4(a), the line segments can be mutually connected by joints and the movement of one segment can be constrained by other, for example, the lower arm will only rotate round the elbow if the upper arm fixes. Furthermore, a few of the parts or line segments can perform the independent motion while the others may keep relative stationary such as a head movement.

In accordance with an exemplary embodiment, the upper torso or center point of the chest, reference point 9 on FIG. 4(a) can be used as a base or reference point for the methods and processes as described herein, since the upper torso and/or center of the chest does not move or only moves slightly with arm gestures and the like, and for example, the upper torso or chest is often visible for attendees and/or users sitting at a table and the like.

FIG. 4(b) shows the spherical coordinate system 410 that can be used to measure the movement of a joint in the 3D space. The position of a line segment in 3D space can be determined by the two jointed associated with this articulated part, as given in Table 1, which is explained in more detail below.

TABLE 1
MOVING COMPONENTS OF HUMAN BODY

| Index | Abbreviation | Description | Associated Joints |
|---|---|---|---|
| 1 | HED | Head | (1, 2) |
| 2 | LSD | Left shoulder | (2, 5) |
| 3 | RSD | right shoulder | (2, 6) |
| 4 | LLA | Left Lower Arm | (3, 4) |
| 5 | LUA | Left upper arm | (4, 5) |
| 6 | RUA | Right upper arm | (6, 7) |
| 7 | RLA | Right lower arm | (7, 8) |
| 8 | LUL | Left upper leg | (10, 11) |
| 9 | LLL | Left lower leg | (11, 12) |
| 10 | RUL | Right upper leg | (13, 14) |
| 11 | RLL | Right lower leg | (14, 15) |

Probability Model

In accordance with an exemplary embodiment, probability modeling, wherein [X₁, X₂, . . . X_{N}], can be a recent sample of the position of an articulated component as defined in Table I. Using this sample, the probability density function that this moving stick (or index) will have at position Xₜ at time t can be estimated using the Parzen window density estimation:

$$P ( {X}_{t} ) = \frac{1}{N} {\sum }_{i = 1}^{N} \frac{1}{{h}_{n}^{d}} K ( \frac{{X}_{t} - {X}_{i}}{{h}_{n}} ) , \qquad ( 1 )$$

where K is a kernel function and hₙ the window width or bandwidth parameter that corresponds to the width of the kernel. If one chooses K to be a normal function N(0, Σ), then,

$$P ( {X}_{t} ) = \frac{1}{N} {\sum }_{i = 1}^{N} \frac{1}{{( 2 π \vert \sum \vert )}^{1 \text{/} 2}} {e}^{- \frac{1}{2} {( {X}_{t} - {X}_{i} )}^{T} {\sum }^{- 1} ( {X}_{t} - {X}_{i} )} , \qquad ( 2 )$$

Since the position of an articulated body part X is determined by two joints in the spherical coordinate system as shown in FIG. 4(b), X=[pⱼ, pₖ]^{T}, where j and k are the indices of two joints, respectively, and p=[γ, θ, Φ)]. If one assumes independence between γ, θ, Φ with different kernel bandwidths, then the density estimation is reduced to

$$P ( {X}_{t} ) = \frac{1}{N} {\sum }_{i = 1}^{N} {\prod }_{υ ∈ \{ r , θ , φ \}}^{ } \frac{1}{{( 2 π \vert {\sum }_{υ} \vert )}^{1 \text{/} 2}} {e}^{- \frac{1}{2} {( {v}_{t} - {v}_{i} )}^{T} {\sum }_{υ}^{- 1} ( {v}_{t} - {v}_{i} )} , \qquad ( 3 )$$

where V=[γⱼ, γₖ]^{T}, [θⱼ, θₖ]^{T}, or [Φⱼ, Φₖ]^{T} and j, k are the indices of two associated joints which define a moving component as given in Table 1. Using this probability estimate, a moving part of the body is considered to be in an action if P(Xₜ)<T, where the threshold T is a global threshold over time that can be empirically set through cross validation and it tunes the sensibility/robustness tradeoff to achieve a desired false positive rate. In accordance with an exemplary embodiment a different moving part can have a different threshold. As shown in Table 1, a skeleton can consist of 11 articulated parts and thus 12 estimators. In accordance with an exemplary embodiment, whether a user is in an action is determined by

P(Xₜ)=(P(Xₜ¹)<T₁)∪, . . . ,∪(P(Xₜ¹²)<T₁₂). (4)

In accordance with an exemplary embodiment, all thresholds for 11 individual articulated parts in the above equation shall empirically set by cross-validation. According to the outputs of Equation 4, then one of the following two hypotheses holds:

$$\{ \begin{matrix}{H}_{0} \text{:} user is in action at t & if P ( {X}_{t} ) = 1 ; \\ {H}_{1} \text{:} user is not in action at t & if P ( {X}_{t} ) = 0.\end{matrix} \qquad ( 5 )$$

After, P(Xₜ), which is one of the following hypotheses holds, which detects the action boundary:

$$\{ \begin{matrix}{H}_{0} \text{:} Action starts & if P ( {X}_{t - 1} ) = 0 , & P ( {X}_{t} ) = 1 ; \\ {H}_{1} \text{:} Acting & if P ( {X}_{t - 1} ) = 1 , & P ( {X}_{t} ) = 1 ; \\ {H}_{2} \text{:} Action ends & if P ( {X}_{t - 1} ) = 1 , & P ( {X}_{t} ) = 0.\end{matrix} \qquad ( 6 )$$

Density estimation using a Normal kernel function is a generalization of the Gaussian mixture model, where each single sample of the N samples is considered to be a Gaussian distribution N(0, Σ) by itself. In accordance with an exemplary embodiment, this allows one to estimate the density function more accurately when N is reasonable large. The estimation depends only on recent information from the sequence. The past information in a Parzen window is removed according to a first-in and first-out manner (see [0053]) so that the model concentrates more on recent observation. As a result, the inevitable errors in estimation can be quickly corrected.

Bandwidth Estimation

In accordance with an exemplary embodiment, the median absolute deviation for the joints associated with a moving part to estimate the bandwidth Σ is computed in Equation 3. That is, the median, m, of |Xᵢ−Xᵢ₊₁| for each consecutive pair (Xᵢ, Xᵢ₊₁) in a Parzen-window 1:N. The pair (Xᵢ, Xᵢ₊₁) usually comes from the same local in time distribution and only few pairs are expected to come from cross distribution. If one assumes that this local in time distribution is normal N(μ, σ²), the standard deviation of (Xᵢ−Xᵢ₊₁) is normal N(0; 2σ²). Then, the standard deviation can be estimated as

$$σ = \frac{1.4826 m}{\sqrt{2}} , \qquad ( 7 )$$

The standard deviation of the product of two such distributions can be estimated from their individual standard deviations, for example,

$$σ = \frac{{σ}_{i} {σ}_{j}}{\sqrt{{σ}_{i}^{2} + {σ}_{j}^{2}}} , \qquad ( 8 )$$

then, the covariance matrix σ in Equation 3 can be estimated from Equations 7 and 8:

$$\sum = 1.099 ( \begin{matrix}{m}_{i}^{2} & \frac{{( {m}_{i} {m}_{j} )}^{2}}{{m}_{i}^{2} + {m}_{j}^{2}} \\ \frac{{( {m}_{i} {m}_{j} )}^{2}}{{m}_{i}^{2} + {m}_{j}^{2}} & {m}_{j}^{2}\end{matrix} ) , \qquad ( 9 )$$

where i and j are the indices of two joints associated with a moving body part at consideration. m represents the median value of (rₖ−rₖ₊₁), (θₖ−θₖ₊₁), or (Øₖ−Øₖ₊₁), k=1, . . . , N.

Parzen-Window Update

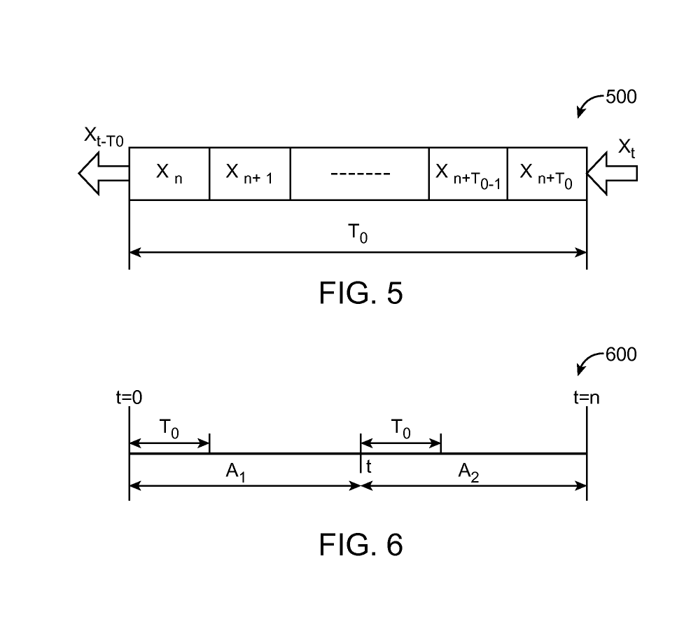

In accordance with an exemplary embodiment, a sample can be used to estimate the Parzen probability density, which contains N values for each joints associated with a moving part. As the algorithm sequentially processes the probability density estimation in this fixed length of window, the sample within the window can be updated continuously to adapt to the change of actions. In accordance with an exemplary embodiment, the window size N can be set to the pre-defined shortest action length T₀, and the update 500 is performed in a first-in first out manner as shown in FIG. 5. The oldest sample X_{t-T}_{₀} in the window is discarded and a new sample Xₜ is added to the window as illustrated in FIG. 5, where X=[γ, θ, Φ)].

Detection Periodic Action

The action boundary detected by the method described above may include a periodic action (cyclic motion). For example, a person is walking. If the action boundary composes of periodic actions, the cut point of a periodic transition shall be detected. In accordance with an exemplary embodiment, the minimal length of an action is denoted by T₀. For example, let [0,n] be the action boundary detected by the previous method. For convenience, the action segmentation [0,n] 600 can be composed of only two periodic action A₁ and A₂ as shown in FIG. 6. In accordance with an exemplary embodiment, a sliding-window strategy with dynamic time warping to test whether the shot founded by the previous method is a periodic action or not can be used. First, the process takes T₀ frames from the beginning of segmentation to perform dynamic time warping over the segmentation as given in Equation 10:

D=F_{DTW}(X_{0:T}_{₀},X_{T}_{₀}_{+1:n}), (10)

where F_{DTW} is a time warping function measuring the structure similarity between two sequences. If there is a match (D<δ) at t as shown in FIG. 6, this indicates the possibility that the action segmentation composes of two periodic actions and their length could be [0,t] and [t+1,n], respectively. To further confirm the existence of periodic actions in [0,n], the sequence match between two sequences [0,t] and [t+1,n] is performed by using dynamic time warping function as follows:

D=F_{DTW}(X_{0:t},X_{t+1:n}), (11)

If <δ, the action segmentation [0,n] exists two periodic actions A₁ and A₂ as shown in FIG. 6. Otherwise, the segmentation is considered as a sequence of one action. For example, the threshold 6 can empirically be set by cross-validation.

### EXAMPLE

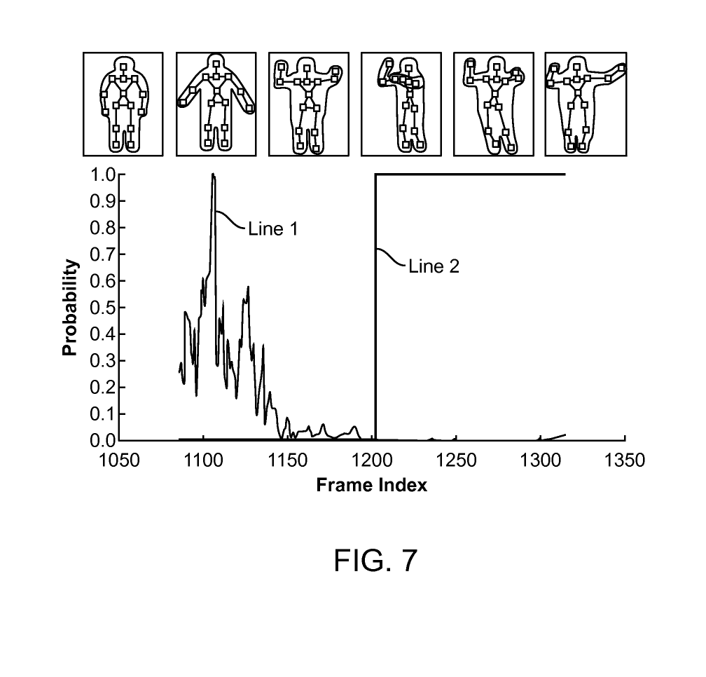

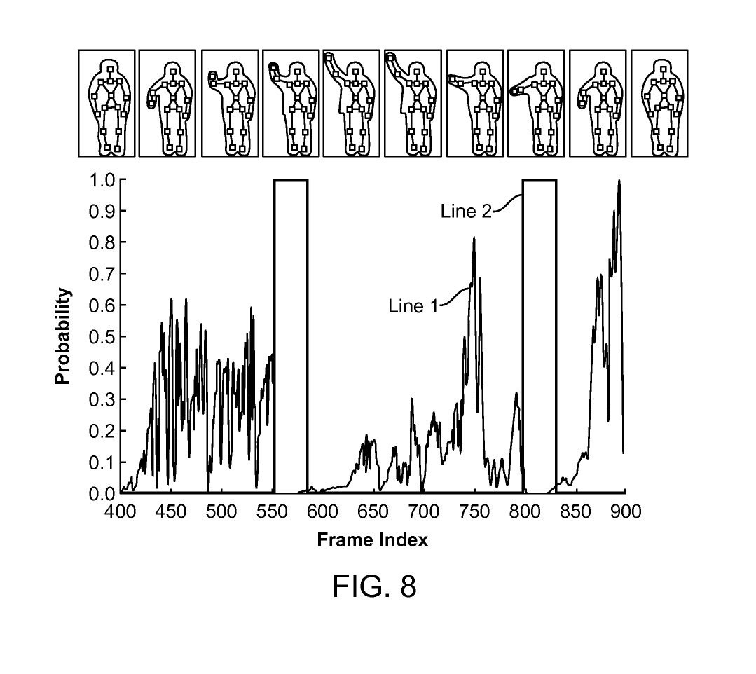

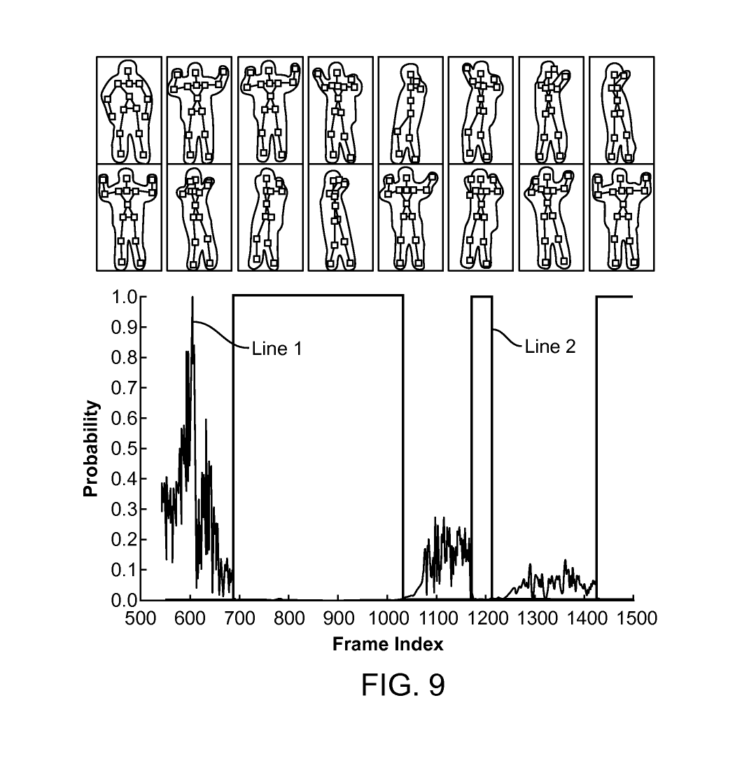

FIG. 7 shows a segmentation result for a single action in which a subject twists the upper body and simultaneously moves the arms. The manual annotated action boundary starts from frame 1198 and the computed action boundary starts from 1204. FIG. 8 shows a result for a subject performing two separate actions where a person raises the hand on frame 556 and then starts to put the hand down on frame 801 after hold the hand for a quite while about 214 frames. The computed boundary for raising the hand is between 555 and 588 and for putting the hand down is between 800 and 826. It can be seen from the above two results that the computed boundary agrees very well with the manual annotation. FIG. 9 shows the detected boundary of three actions where a subject twists the upper body three times and there is a rest between two actions. In accordance with an exemplary embodiment, the manual annotation boundaries of the three actions are [686, 1024], [1172, 1204] and [1432, 1500], respectively. For example, in FIG. 9, the computed boundaries are [690, 1026], [1174, 1208] and [1435, 1504], which closely match the above manually annotated boundaries.

In accordance with an exemplary embodiment, a method for 3D gesture behavior recognition, comprises: obtaining temporal segmentation of human motion sequences for one or more attendees; determining a probability density function of the temporal segmentations of the human motion sequences using a Parzen window density estimation model; computing a bandwidth for determination of a median absolute deviation; updating the Parzen window to adapt for changes in the motion sequences for the one or more attendees; and detecting periodic and non-periodic actions based.

In accordance with another exemplary embodiment, a non-transitory computer readable medium containing a computer program having computer readable code embodied therein for 3D gesture behavior recognition, comprising: obtaining temporal segmentation of human motion sequences for one or more attendees; determining a probability density function of the temporal segmentations of the human motion sequences using a Parzen window density estimation model; computing a bandwidth for determination of a median absolute deviation; updating the Parzen window to adapt for changes in the motion sequences for the one or more attendees; and detecting periodic and non-periodic actions based.

The non-transitory computer usable medium may be a magnetic recording medium, a magneto-optic recording medium, or any other recording medium which will be developed in future, all of which can be considered applicable to the present disclosure in all the same way. Duplicates of such medium including primary and secondary duplicate products and others are considered equivalent to the above medium without doubt. Furthermore, even if an embodiment of the present disclosure is a combination of software and hardware, it does not deviate from the concept of the disclosure at all. The present disclosure may be implemented such that its software part has been written onto a recording medium in advance and will be read as required in operation.

The method and system for 3D gesture behavior recognition as disclosed herein may be implemented using hardware, software or a combination thereof. In addition the method and system for 3D gesture behavior recognition as disclosed herein may be implemented in one or more computer systems or other processing systems, or partially performed in processing systems such as personal digit assistants (PDAs). In yet another embodiment, the disclosure is implemented using a combination of both hardware and software.

It will be apparent to those skilled in the art that various modifications and variation can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for 3D gesture behavior recognition, the method comprising:
detecting a behavior change of one or more attendees at a meeting and/or conference;
classifying the behavior change; and
performing an action based on the behavior change of the one or more attendees.

2. The method of claim 1, wherein the action is one or more of the following:
changing a focus of a video camera and/or audio channel;
giving advice or support to a current speaker; and/or
providing information to a new attendee.

3. The method of claim 1, comprising:
detecting the behavior change of the one or more attendees based on motion detection and/or a visual detection method.

4. The method of claim 1, comprising;
modeling the behavior change to determine intentions and emotion of the one or more attendees using a 3D gesture recognition method.

5. The method of claim 4, wherein the 3D gesture recognition method comprises real-time action segmentation and action transition detection method, which explores non-parametric kernel based probability modeling using motion capture and/or depth sensor data.

6. The method of claim 1, comprising:
generating a spatial segmentation for each of the one or more attendees; and
detecting the behavior change of one or more attendees at attendees at a conference by temporal segmentation of the one or more attendees.

7. The method of claim 6, wherein the temporal segmentation comprises:
representing a body movement by eleven line segments, each line segment having two joints associated therewith;
modeling movement of one of the eleven line segments by a non-parametric kernel based probability density function in a Parzen window;
eliminating an outlier of joint movement by using foreground motion segmentation;
detecting boundaries of action segmentation by a union of eleven line segment probability estimators; and
recognizing actions by fusing a template matching result and a classification result from dynamic time warping and a trained action classifier, respectively.

8. The method of claim 7, comprising:
updating the Parzen window in a first-in first out manner.

9. The method of claim 7, wherein the detected action segmentation is composed of a plurality of actions and/or motions.

10. The method of claim 7, comprising:
using a sliding-window strategy with dynamic time warping to test whether the action segmentation composes of actions; and
finding transitions between the motions.

11. A method for 3D gesture behavior recognition, the method comprising:
obtaining temporal segmentation of human motion sequences for one or more attendees;
determining a probability density function of the temporal segmentations of the human motion sequences using a Parzen window density estimation model;
computing a bandwidth for determination of a median absolute deviation;
updating the Parzen window to adapt for changes in the motion sequences for the one or more attendees; and
detecting actions based.

12. The method of claim 11, wherein the temporal segmentation comprises:
representing a body movement by eleven line segments, each line segment having two joints associated therewith;
modeling movement of one of the eleven line segments by a non-parametric kernel based probability density function in a Parzen window;
eliminating an outlier of joint movement by using foreground motion segmentation;
detecting boundaries of action segmentation by a union of eleven line segment probability estimators; and
recognizing actions by fusing a template matching result and a classification result from dynamic time warping and a trained action classifier, respectively.

13. The method of claim 12, comprising:
updating the Parzen window in a first-in first out manner.

14. The method of claim 12, wherein the detected action segmentation is composed of a plurality of actions (or motions).

15. The method of claim 12, comprising:
using a sliding-window strategy with dynamic time warping to test whether the action segmentation composes of actions; and
finding transitions between the actions.

16. A system for 3D gesture behavior recognition, the system comprising:
a monitoring module having executable instructions for:
obtaining temporal segmentation of human motion sequences for one or more attendees;
determining a probability density function of the temporal segmentations of the human motion sequences using a Parzen window density estimation model;
computing a bandwidth for determination of a median absolute deviation;
updating the Parzen window to adapt for changes in the motion sequences for the one or more attendees; and
detecting actions;
a control module for:
changing the focus of a video camera and/or audio channel;
giving advice or support to a current speaker; and/or
providing information to a new attendee; and
a content management module for:
registering a profile and/or profile information for each individual or attendee at a conference and/or meeting; and/or
summarizing contents of a current conversation and/or meeting for real-time attending assistance and future content browsing.

17. The system of claim 16, wherein the temporal segmentation comprises:
representing a body movement by eleven line segments, each line segment having two joints associated therewith;
modeling movement of one of the eleven line segments by a non-parametric kernel based probability density function in a Parzen window;
eliminating an outlier of joint movement by using a foreground motion segmentation;
detecting action boundaries by a union of eleven line segment probability estimators; and
recognizing actions by fusing a template matching result and a classification result from dynamic time warping and a trained action classifier, respectively.

18. The system of claim 16, comprising:
updating the Parzen window in a first-in first out manner.

19. The system of claim 16, wherein the detected action segmentation is composed of a plurality of actions and/or motions.

20. The system of claim 12, comprising:
using a sliding-window strategy with dynamic time warping to test whether the action segmentation composes of actions; and
finding transitions between the actions.

21. A non-transitory computer readable medium containing a computer program having computer readable code embodied therein for 3D gesture behavior recognition, comprising:
obtaining temporal segmentation of human motion sequences for one or more attendees;
determining a probability density function of the temporal segmentations of the human motion sequences using a Parzen window density estimation model;
computing a bandwidth for determination of a median absolute deviation;
updating the Parzen window to adapt for changes in the motion sequences for the one or more attendees; and
detecting actions based.

22. The computer readable medium of claim 21, wherein the temporal segmentation comprises:
representing a body movement by eleven line segments, each line segment having two joints associated therewith;
modeling movement of one of the eleven line segments by a non-parametric kernel based probability density function in a Parzen window;
eliminating an outlier of joint movement by using a foreground motion segmentation;
detecting action boundaries by a union of eleven line segment probability estimators; and
recognizing actions by fusing a template matching result and a classification result from dynamic time warping and a trained action classifier, respectively.

23. The computer readable medium of claim 22, comprising:
updating the Parzen window in a first-in first out manner.

24. The computer readable medium of claim 22, wherein the detected action segmentation is composed of a plurality of actions and/or motions.

25. The computer readable medium of claim 22, comprising:
using a sliding-window strategy with dynamic time warping to test whether the action segmentation composes of actions; and
finding transitions between the actions.
